(19) United States
(12) Patent Application Publication
(10) Pub. No.: US 2025/0097393 A1
(43) Pub. Date: Mar. 20, 2025

(54) COLOR TEMPERATURE ADJUSTMENT EFFECT DETECTION METHOD AND APPARATUS, COMPUTER DEVICE, MEDIUM, AND PRODUCT

(71) Applicant: Glenfly Tech Co., Ltd., Shanghai (CN)

(72) Inventors: Haotian WANG, Shanghai (CN); Mingjiang WU, Shanghai (CN)

(21) Appl. No.: 18/411,362

(22) Filed: Jan. 12, 2024

(30) Foreign Application Priority Data
Sep. 20, 2023 (CN) 202311221589.3

(51) Int. Cl. H04N 9/73; G06T 7/90; G06V 10/56; G09G 5/02

(52) U.S. Cl. CPC H04N 9/73; G06T 7/90; G06V 10/56; G09G 5/02; G06T 2207/10024; G09G 2320/0666

(57) ABSTRACT

The present disclosure relates to a color temperature adjustment effect detection method and apparatus, a computer device, a storage medium, and a computer program product. A second terminal sends a real standard color temperature to a first terminal, so that the first terminal acquires an actual used color temperature based on the real standard color temperature. Through the first terminal, the actual used color temperature is converted into a target matrix, and the target matrix is embedded into a video frame to obtain an embedded image. Through the first terminal, the embedded image is displayed based on the actual used color temperature, and the embedded image is sent to the second terminal, so that the second terminal parses the embedded image to obtain the actual used color temperature, and acquires an actual rendered color temperature based on a display result of the first terminal.

### CROSS REFERENCE TO RELATED APPLICATIONS

This application claims priority under 35 U.S.C. § 119 to Chinese Patent Application No. 2023112215893, filed on Sep. 20, 2023, the entire content of which is incorporated herein in its entirety.

### TECHNICAL FIELD

The present disclosure relates to the field of graphics processing unit (GPU) detection technologies, and in particular, to a color temperature adjustment effect detection method and apparatus, a computer device, a storage medium, and a computer program product.

### BACKGROUND

In image processing, a color temperature refers to a degree to which an overall color of an image is warmer or cooler. A color temperature of a light source where an object is located is simulated by adjusting a hue of the image. When a color temperature is adjusted, a GPU is generally used. White balance of the image is adjusted so that whites or grays therein look realistic and neutral, to accurately reproduce a color of a shooting scene.

In a conventional method, in order to ensure that the color temperature of the image adjusted by the GPU is consistent with a set color temperature, a color temperature adjustment function of the GPU is required to be detected. At present, detection data and detection images from a slave are generally transmitted to a master over a network, and the GPU is detected through the master.

However, since the image is generally transmitted to the master in a manner such as a desktop screenshot, a change in the color temperature of the image in the slave cannot be effectively captured, resulting in an error in a detected color temperature value.

### SUMMARY

Based on this, there is a need to provide a color temperature adjustment effect detection method and apparatus, a computer device, a computer-readable storage medium, and a computer program product that can improve detection accuracy with respect to the above technical problems.

In a first aspect, the present disclosure provides a color temperature adjustment effect detection method, applied to a first terminal, the method including:
acquiring an actual used color temperature obtained based on a real standard color temperature sent by a second terminal;
converting the actual used color temperature into a target matrix carrying the actual used color temperature, and embedding the target matrix into a video frame to obtain an embedded image; and
displaying the embedded image based on the actual used color temperature, and sending the embedded image to the second terminal, so that the second terminal parses the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

In an embodiment, the step of converting the actual used color temperature into the target matrix carrying the actual used color temperature includes:
converting the actual used color temperature into a binary string, and converting the binary string into a grayscale value string;
determining a matrix row number and a matrix column number according to a number of bits of the grayscale value string;
filling a matrix framework determined by the matrix row number and the matrix column number with the grayscale value string according to the number of bits, to obtain an initial matrix; and
acquiring the target matrix based on the initial matrix.

In an embodiment, the step of acquiring the target matrix based on the initial matrix includes:
adding null values to the initial matrix to obtain a dilated matrix; and
dimensionally expanding the dilated matrix based on a number of display channels of the video frame, to obtain the target matrix.

In an embodiment, the embedding the target matrix into the video frame to obtain the embedded image includes:
determining an embedding region of the target matrix; and
replacing image content in the embedding region with the target matrix, to obtain the embedded image.

In an embodiment, the method further includes: prior to the sending the embedded image to the second terminal,

sending a video frame into which an indication matrix is embedded to the second terminal, and displaying the video frame, the indication matrix being configured to prompt the second terminal to prepare to display the embedded image.

In a second aspect, the present disclosure provides a color temperature adjustment effect detection method, applied to a second terminal, the method including:
sending a real standard color temperature to the first terminal, so that the first terminal acquires an actual used color temperature obtained based on the real standard color temperature, converts the actual used color temperature into a target matrix carrying the actual used color temperature, embeds the target matrix into a video frame to obtain an embedded image, and displays the embedded image based on the actual used color temperature;
acquiring the embedded image returned by the first terminal, and parsing the embedded image to obtain the actual used color temperature;
acquiring an actual rendered color temperature based on a display result of the first terminal; and
acquiring a color temperature adjustment effect of the first terminal based on the real standard color temperature, the actual used color temperature, and the actual rendered color temperature.

In an embodiment, the method further includes: prior to the parsing the embedded image,
storing acquired embedded images to a cache region based on timestamps of the acquired embedded images; and
selecting, in order of the timestamps, the embedded image corresponding to the earliest timestamp for parsing.

In an embodiment, the step of parsing the embedded image to obtain the actual used color temperature includes:
acquiring the target matrix from the embedded image according to an embedding region in the embedded image;
dimensionally reducing the target matrix to obtain a dilated matrix;
removing null values in the dilated matrix to obtain an initial matrix; and
acquiring a grayscale value string based on the initial matrix, converting the grayscale value string into a binary string, and converting the binary string into the actual used color temperature.

In an embodiment, the step of acquiring the color temperature adjustment effect of the first terminal based on the real standard color temperature, the actual used color temperature, and the actual rendered color temperature includes:
determining that the adjustment is abnormal when at least one of the actual used color temperature and the actual rendered color temperature is inconsistent with the real standard color temperature;
acquiring a device number of the first terminal when the adjustment of the first terminal is abnormal; and
taking the embedded image as abnormal information, and saving the abnormal information and the device number to a target database as the color temperature adjustment effect.

In a third aspect, the present disclosure further provides a color temperature adjustment effect detection apparatus, including:
a color temperature acquisition module configured to acquire an actual used color temperature obtained based on a real standard color temperature sent by a second terminal;
an image acquisition module configured to convert the actual used color temperature into a target matrix carrying the actual used color temperature, and embed the target matrix into a video frame to obtain an embedded image; and
an image display module configured to display the embedded image based on the actual used color temperature, and send the embedded image to the second terminal, so that the second terminal analyzes the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

In a fourth aspect, the present disclosure further provides a color temperature adjustment effect detection apparatus, including:
a color temperature sending module configured to send a real standard color temperature to the first terminal, so that the first terminal acquires an actual used color temperature obtained based on the real standard color temperature, converts the actual used color temperature into a target matrix carrying the actual used color temperature, embeds the target matrix into a video frame to obtain an embedded image, and displays the embedded image based on the actual used color temperature;
an image parsing module configured to acquire the embedded image returned by the first terminal, and parse the embedded image to obtain the actual used color temperature;
a color temperature acquisition module configured to acquire an actual rendered color temperature based on a display result of the first terminal; and
an effect acquisition module configured to acquire a color temperature adjustment effect of the first terminal based on the real standard color temperature, the actual used color temperature, and the actual rendered color temperature.

In a fifth aspect, the present disclosure further provides a computer device, including a memory and a processor, the memory storing a computer program, wherein the processor, when executing the computer program, implements steps in the method in either of the first aspect and the second aspect.

In a sixth aspect, the present disclosure further provides a computer-readable storage medium, storing a computer program, wherein, when the computer program is executed by a processor, steps in the method in either of the first aspect and the second aspect are implemented.

In a seventh aspect, the present disclosure further provides a computer program product, including a computer program, wherein, when the computer program is executed by a processor, steps in the method in either of the first aspect and the second aspect are implemented.

In the color temperature adjustment effect detection method and apparatus, the computer device, the storage medium, and the computer program product described above, the second terminal sends the real standard color temperature to the first terminal, so that the first terminal acquires the actual used color temperature based on the real standard color temperature. Through the first terminal, the actual used color temperature is converted into the target matrix, and the target matrix is embedded into the video frame to obtain the embedded image. Through the first terminal, the embedded image is displayed based on the actual used color temperature, and the embedded image is sent to the second terminal, so that the second terminal parses the embedded image to obtain the actual used color temperature, and acquires the actual rendered color temperature based on the display result of the first terminal. Through the second terminal, the color temperature adjustment effect of the first terminal can be accurately acquired based on the real standard color temperature, the actual used color temperature, and the actual rendered color temperature, thereby improving detection accuracy of the color temperature adjustment function of the first terminal.

### BRIEF DESCRIPTION OF THE DRAWINGS

In order to more clearly illustrate the technical solutions in embodiments of the present disclosure or the related art, the accompanying drawings used in the description of the embodiments or the related art will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a diagram of an application environment of a color temperature adjustment effect detection method according to an embodiment;

FIG. 2 is a schematic flowchart of the color temperature adjustment effect detection method according to an embodiment;

FIG. 3 is a schematic flowchart of the color temperature adjustment effect detection method according to an embodiment;

FIG. 4 is a schematic flowchart of the color temperature adjustment effect detection method according to an embodiment;

FIG. 5 is a schematic diagram of an embedded image according to an embodiment;

FIG. 6 is a schematic flowchart of a step of storing the embedded image to a cache region according to an embodiment;

FIG. 7 is a schematic diagram of a step of parsing the embedded image according to an embodiment;

FIG. 8 is a schematic structural diagram of a color temperature adjustment effect detection apparatus according to an embodiment;

FIG. 9 is a schematic structural diagram of the color temperature adjustment effect detection apparatus according to an embodiment; and

FIG. 10 is a diagram of an internal structure of a computer device according to an embodiment.

### DETAILED DESCRIPTION OF THE EMBODIMENTS

In order to make the objectives, technical solutions, and advantages of the present disclosure clearer, the present disclosure will be further described in detail below with reference to the accompanying drawings and embodiments. It should be understood that specific embodiments described herein are intended only to explain the present disclosure and are not intended to limit the present disclosure.

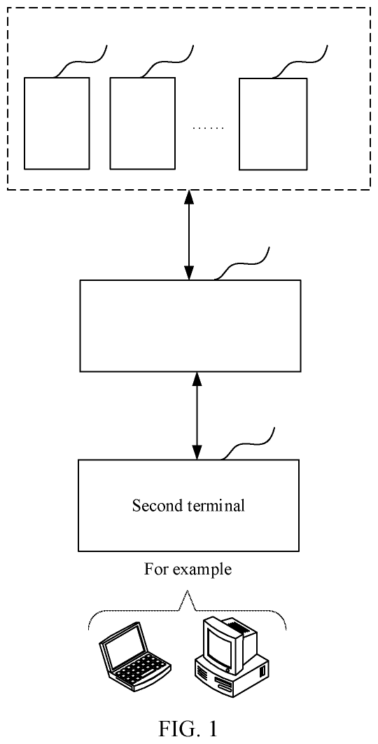

A color temperature adjustment effect detection method provided in some embodiments of the present disclosure may be applied to an application environment as shown in FIG. 1. A plurality of first terminals 102 communicate with a second terminal 106 through a digital interface 104. For each first terminal 102, the first terminal 102 is configured to acquire an actual used color temperature obtained based on a real standard color temperature sent by the second terminal 106, convert the actual used color temperature into a target matrix carrying the actual used color temperature, embed the target matrix into a video frame to obtain an embedded image, display the embedded image based on the actual used color temperature, and send the embedded image to the second terminal 106, so that the second terminal 106 analyzes the embedded image to obtain the actual used color temperature, acquires an actual rendered color temperature based on a display result, and acquires a color temperature adjustment effect of the first terminal 102 based on the real standard color temperature, the actual used color temperature, and the actual rendered color temperature. The first terminal 102 and the second terminal 106 may be, but are not limited to, various personal computers, notebooks, and the like. The digital interface 104 may be a high-definition multimedia interface (HDMI).

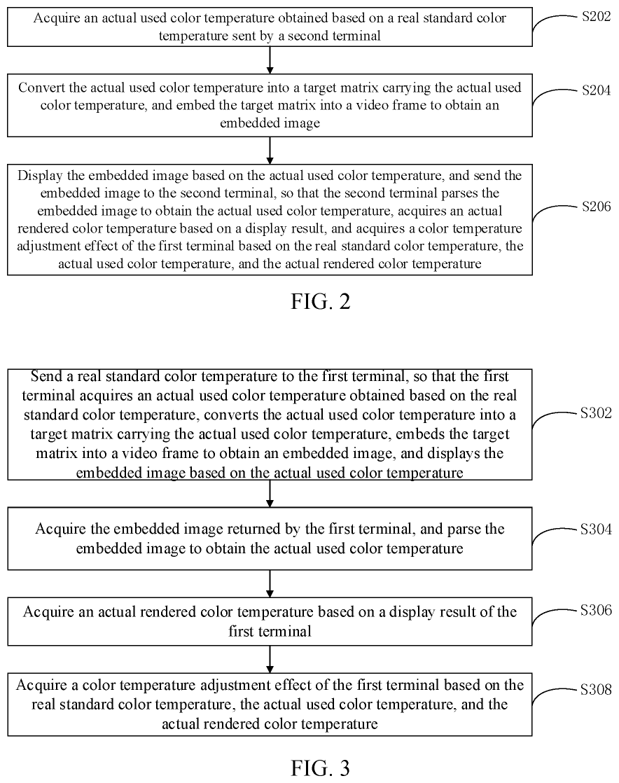

In an exemplary embodiment, as shown in FIG. 2, a color temperature adjustment effect detection method is provided. For example, the method is applied to the first terminal 102 in FIG. 1, including the following step 202 to step 206.

In S202, an actual used color temperature obtained based on a real standard color temperature sent by a second terminal is acquired.

A color temperature refers to warmth or coldness of a color rendered by a light source, which is an indicator used to describe a color characteristic of light emitted by the light source. The color temperature of the light source is related to a temperature of the light source, measured in kelvins (K), which indicates similarity between a color of the light emitted by the light source and a color of a thermal radiation source at absolute zero (−273.15° C.). For example, a color temperature of a common fluorescent lamp or natural light is about 5000 K to 6000 K. In practical applications, by adjusting a color temperature parameter of GPU software, an overall color of an image may be changed to be warmer or cooler, so that the image after adjustment is closer to a color temperature under real light.

Specifically, the first terminal serves as a detector, and the GPU software is required to be installed locally in advance. The second terminal serves as a control host and sends a real standard color temperature to the first terminal. Herein, the real standard color temperature refers to a color temperature of the image that is expected to be adjusted by the first terminal according to the color temperature value, and the actual used color temperature refers to a color temperature used by the first terminal to actually adjust the color temperature of the image.

In S204, the actual used color temperature is converted into a target matrix carrying the actual used color temperature, and the target matrix is embedded into a video frame to obtain an embedded image.

Since the color temperature is required to be collected through a special device and software, in a conventional method, when the GPU software is checked, the detector is generally networked with a detection server, and images on the detector are transmitted to the detection server for detection. In this way, special software is required only to be installed locally on a network server, and is not required to be installed on each detector. However, during the transmission of the images on the detector to the detection server, due to a long distance of network transmission, it is easy to introduce additional noise, leading to deviation of the color temperature detected by the detection server, thereby affecting a detection result.

Based on this, in order to prevent a change in the image during image transmission, the first terminal encrypts the actual used color temperature, “hides” the actual used color temperature in the target matrix, and embeds the target matrix into the video frame to form the embedded image. In this way, after receiving the embedded image, the second terminal decrypts the target matrix and can obtain an accurate actual used color temperature. In practical applications, a physical connection is established between the first terminal and the second terminal through a digital interface, such as an HDMI or a display port (DP) interface, and security and authenticity of the embedded image can be ensured through short-range physical transmission.

In S206, the embedded image is displayed based on the actual used color temperature, and the embedded image is sent to the second terminal, so that the second terminal parses the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

The first terminal displays the embedded image through a graphics view framework (a QT graphical interface), during the display, adjusts a color temperature of the embedded image according to the actual used color temperature through the GPU software, and sends the embedded image to the second terminal. The second terminal parses the received image to obtain the target matrix embedded by the first terminal, thereby obtaining the actual used color temperature of the first terminal by parsing. At the same time, the second terminal acquires the actual rendered color temperature of the first terminal through the HDMI. Specifically, the color temperature acquired by the second terminal through the HDMI is directly acquired from a software layer of the first terminal, and the color temperature transmitted over the network is generally a displayed color temperature acquired by taking a screenshot of a display interface of the first terminal. This manner of acquiring the color temperature may be affected by settings of a display screen of the first terminal, and the actual rendered color temperature acquired from the software layer is real data after interference from the first terminal device is eliminated.

Further, the second terminal acquires the color temperature adjustment effect of the first terminal based on the real standard color temperature, the actual used color temperature, and the actual rendered color temperature. When either of the actual used color temperature and the actual rendered color temperature is inconsistent with the real standard color temperature, it is determined that color temperature adjustment of the first terminal is abnormal. Since a detection process is performed for each video frame in a video, the second terminal can record video frames with abnormal color temperature adjustment in real time, so that detection personnel can subsequently analyze the GPU software on the first terminal. It is to be noted that the second terminal is connected to the plurality of first terminals respectively. When performing detection, each first terminal may send a corresponding embedded image to the second terminal. In the case of abnormal color temperature adjustment, in order to accurately distinguish a specific position of abnormality, the HDMI may be numbered. During the communication of the first terminal with the second terminal through the HDMI, the second terminal may record a source interface of the embedded image in each frame, thereby facilitating the detection personnel to position the position of abnormality.

In the color temperature adjustment effect detection method described above, the second terminal sends the real standard color temperature to the first terminal, so that the first terminal acquires the actual used color temperature based on the real standard color temperature. Through the first terminal, the actual used color temperature is converted into the target matrix, and the target matrix is embedded into the video frame to obtain the embedded image. Through the first terminal, the embedded image is displayed based on the actual used color temperature, and the embedded image is sent to the second terminal, so that the second terminal parses the embedded image to obtain the actual used color temperature, and acquires the actual rendered color temperature based on the display result of the first terminal. Through the second terminal, the color temperature adjustment effect of the first terminal can be accurately acquired based on the real standard color temperature, the actual used color temperature, and the actual rendered color temperature, thereby improving detection accuracy of the color temperature adjustment function of the first terminal.

In an exemplary embodiment, the step of converting the actual used color temperature into the target matrix carrying the actual used color temperature includes: converting the actual used color temperature into a binary string, and converting the binary string into a grayscale value string; determining a matrix row number and a matrix column number according to a number of bits of the grayscale value string; filling a matrix framework determined by the matrix row number and the matrix column number with the grayscale value string according to the number of bits, to obtain an initial matrix; and acquiring the target matrix based on the initial matrix.

In order to save the actual used color temperature to the video frame, the first terminal converts the actual used color temperature into the target matrix carrying the actual used color temperature, so that the actual used color temperature corresponds to the video frame. In practical applications, video frames are generally pure black or pure white images, and corresponding color values are all 0 or all 255. The two color values have the least impact on the color temperature. Therefore, values in the target matrix should also be 0 or 255.

Specifically, the first terminal converts the actual used color temperature into the binary string, and assigns “1” and “0” in the binary string to 0 or 255 respectively to obtain a grayscale value string. In practical applications, a numerical range of the color temperature is generally from 1000 K to 25000 K. Correspondingly, a number of bits of the binary string obtained by conversion is generally from 9 to 15. Therefore, a product of the matrix row number and the column number is required to be greater than 15. Herein, in order to facilitate the second terminal to disassemble the matrix and restore the value of the actual used color temperature, a 4×4 matrix framework may be selected, and the matrix framework is filled sequentially with the grayscale value string according to the number of bits to obtain the initial matrix. The initial matrix obtained in this case is a two-dimensional matrix, and the initial matrix is required to be converted into the target matrix corresponding to the video frame.

In this embodiment, the actual used color temperature is converted into the binary string, the binary string is converted into the grayscale value string that the determined matrix framework is filled with according to the number of bits, to obtain the initial matrix, and the target matrix is acquired based on the initial matrix, which can ensure security of the actual used color temperature during data transmission, thereby accurately acquiring the color temperature adjustment effect of the first terminal.

In an exemplary embodiment, the step of acquiring the target matrix based on the initial matrix includes: adding null values to the initial matrix to obtain a dilated matrix; and dimensionally expanding the dilated matrix based on a number of display channels of the video frame, to obtain the target matrix.

In order to further ensure the security of the actual used color temperature, the first terminal adds randomly sized null values to the initial matrix to obtain the dilated matrix. Adding the null values can expand a receptive field without losing resolution, allowing the second terminal to position the matrix more accurately. Generally, a dimension of the dilated matrix is from 4×4 to 20×20. A matrix that is excessively large may cause the second terminal to process more data during the parsing. Then, the first terminal dimensionally expands the dilated matrix based on the number of the display channels of the video frame, to obtain the target matrix. Herein, the number of the display channels of the video frame is generally 3. That is, the first terminal expands the initial matrix into a three-dimensional matrix. Specifically, for example, a value in a certain row and a certain column of the dilated matrix is 255. After dimensional expansion, the value at the position becomes (255, 255, 255), and so on, and finally the target matrix is obtained.

In this embodiment, the null values are added to the initial matrix to obtain the dilated matrix, and the dilated matrix is dimensionally expanded based on the number of the display channels of the video frame, to obtain the target matrix, which enables the target matrix to be a matrix matching the number of the display channels of the video frame, so that the target matrix can be embedded into the video frame, thereby ensuring security of the actual used color temperature.

In an exemplary embodiment, the step of embedding the target matrix into the video frame to obtain the embedded image includes: determining an embedding region of the target matrix; and replacing image content in the embedding region with the target matrix, to obtain the embedded image.

During the embedding of the target matrix into the video frame, the first terminal first determines an embedding region of the target matrix in the video frame. Generally, selection of a middle region of the video frame can achieve an optimal effect. Specifically, for each pixel in the embedding region, the first terminal replaces a color value corresponding to the pixel with a value at a corresponding position in the target matrix, thereby replacing the image content in the embedding region with the target matrix to obtain the embedded image.

In this embodiment, the embedding region of the target matrix is determined, and the image content in the embedding region is replaced with the target matrix to obtain the embedded image, which can ensure security of the actual used color temperature during data transmission, thereby accurately acquiring the color temperature adjustment effect of the first terminal.

In an exemplary embodiment, prior to the sending the embedded image to the second terminal, the method further includes: sending a video frame into which an indication matrix is embedded to the second terminal, and displaying the video frame, the indication matrix being configured to prompt the second terminal to prepare to display the embedded image.

Before the first terminal sends the embedded image to the second terminal, the video frame into which the indication matrix is embedded may be first sent to the second terminal, and the video frame is displayed. An indicator matrix whose values are all 255 is embedded into the video frame in this case. After receiving the video frame, the second terminal identifies the video frame. When existence of the indication matrix is recognized, it indicates that the first terminal has completed the color temperature adjustment of the embedded image in this case, and the color temperature of the embedded image is stable. The first terminal is about to send the embedded image to the second terminal, and the second terminal prepares to display the embedded image.

In this embodiment, the video frame into which the indication matrix is embedded is sent to the second terminal, and the video frame is displayed to prompt the second terminal to prepare to display the embedded image, which can ensure that the embedded image received by the second terminal is stable, thereby ensuring accurate acquisition of the color temperature adjustment effect of the first terminal.

In an exemplary embodiment, as shown in FIG. 3, a color temperature adjustment effect detection method is provided. For example, the method is applied to the second terminal 106 in FIG. 1, including the following step 302 to step 308.

In S302, a real standard color temperature is sent to the first terminal, so that the first terminal acquires an actual used color temperature obtained based on the real standard color temperature, converts the actual used color temperature into a target matrix carrying the actual used color temperature, embeds the target matrix into a video frame to obtain an embedded image, and displays the embedded image based on the actual used color temperature.

The second terminal serves as a control host and sends the real standard color temperature to the first terminal. The real standard color temperature is a standard color temperature when the first terminal is expected to adjust the color temperature, so that the first terminal acquires the actual used color temperature based on the real standard color temperature, converts the actual used color temperature into the target matrix, and embeds the target matrix into the video frame to obtain the embedded image. In addition, the first terminal further displays the embedded image based on the actual used color temperature, and the second terminal acquires the embedded image through the HDMI, which may be displayed simultaneously, and a display situation of the first terminal is monitored in real time.

In S304, the embedded image returned by the first terminal is acquired, and the embedded image is parsed to obtain the actual used color temperature.

When receiving the embedded image sent by the first terminal, the second terminal may parse the embedded image to obtain the target matrix, and restore the target matrix to the actual used color temperature converted by the first terminal. The actual used color temperature indicates a color temperature actually used by the first terminal when adjusting the color temperature. Specifically, when the GPU software is abnormal, the color temperature of the video frame cannot be adjusted according to the real standard color temperature through the GPU software. In this case, the real standard color temperature may be modified due to specific optimization. That is, the actual used color temperature is inconsistent with the real standard color temperature, thereby affecting the color temperature adjustment effect of the first terminal acquired by the second terminal. Therefore, the second terminal can eliminate the interference by verifying the actual used color temperature obtained by parsing.

In S306, an actual rendered color temperature is acquired based on a display result of the first terminal.

During the display of the embedded image by the first terminal, the second terminal acquires the actual rendered color temperature of the first terminal through the HDMI. The actual rendered color temperature in this case is an actual color temperature on a software layer of the first terminal, which represents an actual rendering effect of the first terminal.

In S308, a color temperature adjustment effect of the first terminal is acquired based on the real standard color temperature, the actual used color temperature, and the actual rendered color temperature.

When the actual used color temperature obtained by parsing is inconsistent with the real standard color temperature, it indicates that specific optimization has occurred in the GPU software in the first terminal, causing the real standard color temperature sent by the second terminal to be modified. Then, it is determined that color temperature adjustment of the GPU software of the first terminal is abnormal. In this case, even if the actual rendered color temperature is consistent with the actual used color temperature, a processing result of the second terminal may not be affected. When the actual rendered color temperature is inconsistent with the real standard color temperature, it indicates that the first terminal cannot accurately adjust the color temperature of the video frame to the real standard color temperature. In this case, even if the actual used color temperature is consistent with the real standard color temperature, it is still determined that the GPU software of the first terminal is abnormal.

In this embodiment, the second terminal sends the real standard color temperature to the first terminal, so that the first terminal acquires the actual used color temperature based on the real standard color temperature. Through the first terminal, the actual used color temperature is converted into the target matrix, and the target matrix is embedded into the video frame to obtain the embedded image. Through the first terminal, the embedded image is displayed based on the actual used color temperature, and the embedded image is sent to the second terminal, so that the second terminal parses the embedded image to obtain the actual used color temperature, and acquires the actual rendered color temperature based on the display result of the first terminal. Through the second terminal, the color temperature adjustment effect of the first terminal can be accurately acquired based on the real standard color temperature, the actual used color temperature, and the actual rendered color temperature, thereby improving detection accuracy of the color temperature adjustment function of the first terminal.

In an exemplary embodiment, prior to the parsing the embedded image, the method further includes: storing acquired embedded images to a cache region based on timestamps of the acquired embedded images; and selecting, in order of the timestamps, the embedded image corresponding to the earliest timestamp for parsing.

Since the embedded image sent by each first terminal to the second terminal is a series of continuous video frames, when the second terminal parses the embedded image, in order to ensure continuous parsing without interference from other video frames, the second terminal is divided into two regions locally. One of the regions is used as a cache region. The second terminal sequentially stores acquired embedded images in the cache region according to timestamps of the embedded images, and during each parsing, selects, in order of the timestamps, the embedded image corresponding to the earliest timestamp to enter a parsing region for parsing. It is to be noted that, before receiving the embedded image, the second terminal may receive the video frame sent by the first terminal and with the indication matrix embedded therein. The video frame in this case does not enter the cache region, but only serves as a prompt signal to prompt the second terminal that it is about to receive the embedded image sent by the first terminal.

In this embodiment, the acquired embedded images are stored in the cache region based on the timestamps of the acquired embedded images, and the embedded image corresponding to the earliest timestamp is selected in order of the timestamps for parsing, which can separate the parsing region from the cache region and prevent interference caused by multiple video frames during the parsing, thereby improving processing efficiency of the second terminal.

In an exemplary embodiment, the step of parsing the embedded image to obtain the actual used color temperature includes: acquiring a target matrix from the embedded image according to an embedding region in the embedded image; dimensionally reducing the target matrix to obtain a dilated matrix; removing null values in the dilated matrix to obtain an initial matrix; and acquiring a grayscale value string based on the initial matrix, converting the grayscale value string into a binary string, and converting the binary string into the actual used color temperature.

When parsing the embedded image, the second terminal is first required to position the embedding region in the embedded image. In practical applications, since the video frame is an image with all color values of 1 or 255, and the values in the embedded target matrix include 0 and 255, the embedding region can be well distinguished from other regions of the video frame image, so that the second terminal quickly positions the embedding region to obtain the target matrix, thereby acquiring the target matrix. In this case, the acquired target matrix is a matrix matching the number of the display channels of the video frame. Therefore, the second terminal is required to dimensionally reduce the target matrix to the two-dimensional matrix to obtain the dilated matrix, and remove the null values in the dilated matrix to obtain the initial matrix. The second terminal restores the initial matrix to the grayscale value string according to the matrix row number and the matrix column number, and converts the grayscale value string into the binary string to restore the actual used color temperature.

In this embodiment, the target matrix is acquired from the embedded image according to the embedding region in the embedded image, the target matrix is dimensionally reduced to obtain the dilated matrix, the null values in the dilated matrix are removed to obtain the initial matrix, and the grayscale value string is acquired based on the initial matrix, the grayscale value string is converted into the binary string, and the binary string is converted into the actual used color temperature, which can accurately obtain the actual used color temperature embedded by the first terminal, thereby accurately acquiring the color temperature adjustment effect of the first terminal.

In an exemplary embodiment, the step of acquiring the color temperature adjustment effect of the first terminal based on the real standard color temperature, the actual used color temperature, and the actual rendered color temperature includes: determining that the adjustment is abnormal when at least one of the actual used color temperature and the actual rendered color temperature is inconsistent with the real standard color temperature; acquiring a device number of the first terminal when the adjustment of the first terminal is abnormal; and taking the embedded image as abnormal information, and saving the abnormal information and the device number to a target database as the color temperature adjustment effect.

When the actual used color temperature obtained by parsing is inconsistent with the real standard color temperature, it indicates that specific optimization has occurred in the GPU software in the first terminal, causing the real standard color temperature sent by the second terminal to be modified. Then, it is determined that color temperature adjustment of the GPU software of the first terminal is abnormal. In this case, even if the actual rendered color temperature is consistent with the actual used color temperature, a processing result of the second terminal may not be affected. When the actual rendered color temperature is inconsistent with the real standard color temperature, it indicates that the first terminal cannot accurately adjust the color temperature of the video frame to the real standard color temperature. In this case, even if the actual used color temperature is consistent with the real standard color temperature, it is still determined that the GPU software of the first terminal is abnormal. When it is determined that the adjustment of the first terminal is abnormal, the device number of the first terminal is acquired according to a number of the HDMI, and the second terminal takes the embedded image as abnormal information and saves the abnormal information and the device number to the target database as the color temperature adjustment effect corresponding to the first terminal. This allows an inspector to subsequently debug the GPU software in the first terminal based on the color temperature adjustment effect saved in the target database.

In this embodiment, it is determined that the adjustment is abnormal when at least one of the actual used color temperature and the actual rendered color temperature is inconsistent with the real standard color temperature, the device number of the first terminal is acquired when the adjustment of the first terminal is abnormal, the embedded image is taken as abnormal information, and the abnormal information and the device number are saved to the target database as the color temperature adjustment effect, which can accurately acquire the color temperature adjustment effect of the first terminal, thereby achieving effective detection of the color temperature adjustment function of the first terminal.

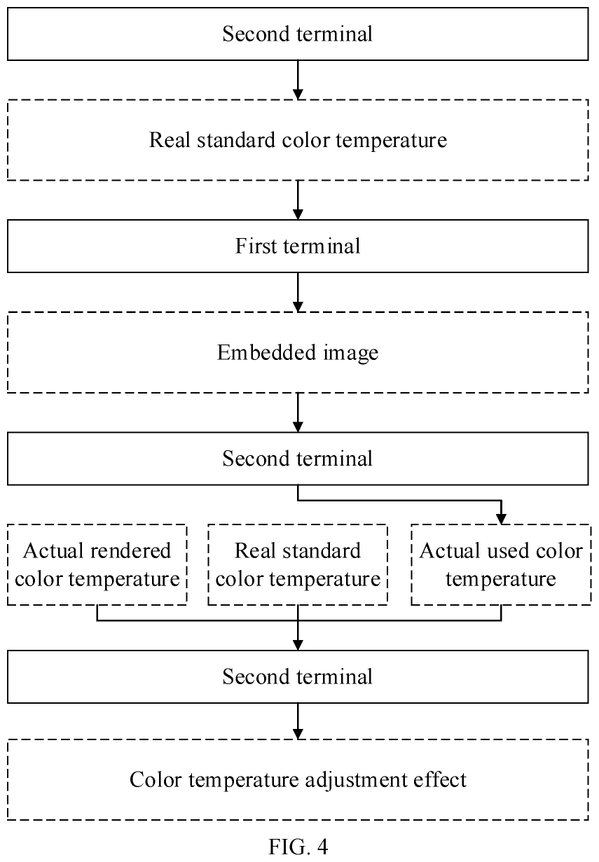

In an exemplary embodiment, as shown in FIG. 4, a color temperature adjustment effect detection method is provided, including the following steps.

A second terminal sends a real standard color temperature to a first terminal.

The first terminal acquires an actual used color temperature obtained based on the real standard color temperature sent by the second terminal.

The first terminal converts the actual used color temperature into a binary string, and converts the binary string into a grayscale value string; determines a matrix row number and a matrix column number according to a number of bits of the grayscale value string; fills a matrix framework determined by the matrix row number and the matrix column number with the grayscale value string according to the number of bits, to obtain an initial matrix; adds null values to the initial matrix to obtain a dilated matrix; and dimensionally expands the dilated matrix based on a number of display channels of a video frame, to obtain a target matrix.

The first terminal determines an embedding region of the target matrix; and replaces image content in the embedding region with the target matrix, to obtain the embedded image.

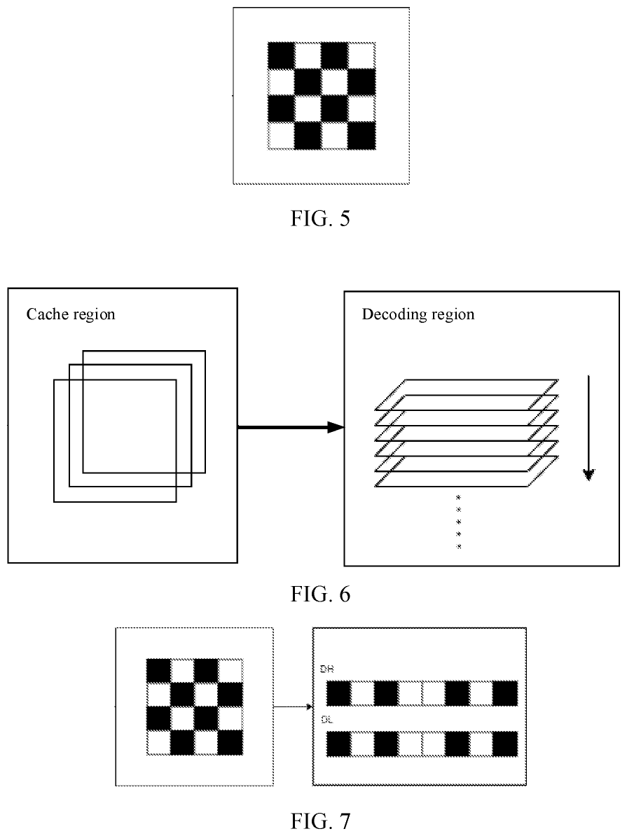

The embedded image obtained is shown in FIG. 5. In FIG. 5, the outermost box represents a complete image of the video frame, the middle box represents the embedded region, and the black and white part is the target matrix.

The first terminal sends a video frame into which an indication matrix is embedded to the second terminal, and displays the video frame. The indication matrix is used to prompt the second terminal to prepare to display the embedded image.

The first terminal displays the embedded image based on the actual used color temperature, and sends the embedded image to the second terminal.

The second terminal stores acquired embedded images to a cache region based on timestamps of the acquired embedded images; and selects, in order of the timestamps, the embedded image corresponding to the earliest timestamp for parsing.

As shown in FIG. 6, the second terminal sequentially saves the embedded images to the cache region according to the timestamps, and selects, in order of the timestamps, the embedded image corresponding to the earliest timestamp to enter a parsing region for parsing.

The second terminal acquires the target matrix from the embedded image according to the embedding region in the embedded image; dimensionally reduces the target matrix to obtain the dilated matrix; removes the null values in the dilated matrix to obtain the initial matrix; and acquires the grayscale value string based on the initial matrix, converts the grayscale value string into the binary string, and converts the binary string into the actual used color temperature.

A process of parsing, by the second terminal, the embedded image to obtain the grayscale value string is shown in FIG. 7. In FIG. 7, the left side of the arrow represents the embedded image received by the second terminal, and the right side of the arrow represents the grayscale value string obtained according to the matrix row number and the matrix column number.

The second terminal acquires an actual rendered color temperature based on a display result of the first terminal.

The second terminal determines that the adjustment is abnormal when at least one of the actual used color temperature and the actual rendered color temperature is inconsistent with the real standard color temperature; acquires a device number of the first terminal when the adjustment of the first terminal is abnormal; and takes the embedded image as abnormal information, and saves the abnormal information and the device number to a target database as the color temperature adjustment effect.

In this embodiment, for the detection of the color temperature adjustment function, unattended all-day detection can be achieved. Communication stability is high, data security is good, and detection efficiency can be greatly improved.

It should be understood that, although the steps in the flowcharts involved in the above embodiments are displayed in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts involved in the above embodiments may include a plurality of steps or a plurality of stages, and such steps or stages are not necessarily performed at a same moment, and may be performed at different moments. The steps or stages are not necessarily performed in sequence, and the steps or stages and at least some of other steps or steps or stages of other steps may be performed in turn or alternately.

Based on a same inventive concept, embodiments of the present disclosure further provide a color temperature adjustment effect detection apparatus configured to implement the color temperature adjustment effect detection method as referred to above. The implementation solution to the problem provided by the apparatus is similar to the implementation solution described in the method above. Therefore, the specific limitation in one or more embodiments of the color temperature adjustment effect detection apparatus provided below may be obtained with reference to the limitation on the color temperature adjustment effect detection method above. Details are not described herein again.

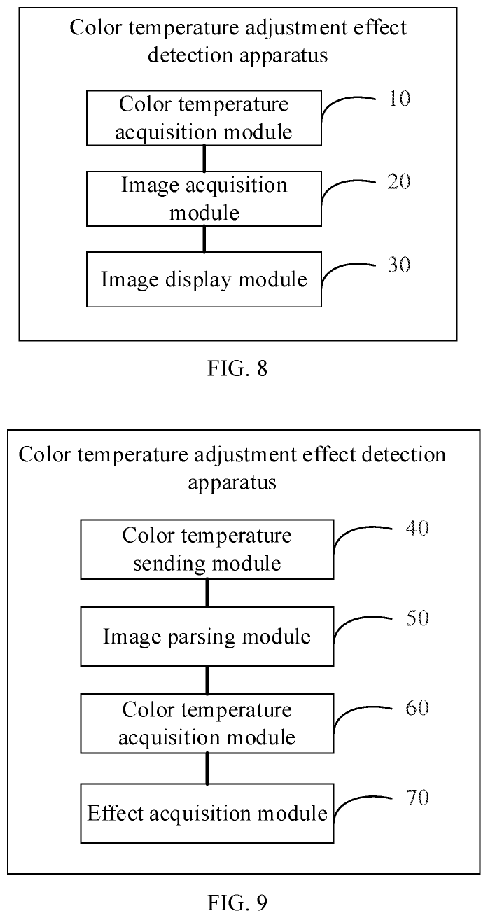

In an exemplary embodiment, as shown in FIG. 8, a color temperature adjustment effect detection apparatus is provided, including: a color temperature acquisition module 10, an image acquisition module 20, and an image display module 30.

The color temperature acquisition module 10 is configured to acquire an actual used color temperature obtained based on a real standard color temperature sent by a second terminal.

The image acquisition module 20 is configured to convert the actual used color temperature into a target matrix carrying the actual used color temperature, and embed the target matrix into a video frame to obtain an embedded image.

The image display module 30 is configured to display the embedded image based on the actual used color temperature, and send the embedded image to the second terminal, so that the second terminal analyzes the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

In an exemplary embodiment, the image acquisition module 20 is further configured to convert the actual used color temperature into a binary string, and convert the binary string into a grayscale value string; determine a matrix row number and a matrix column number according to a number of bits of the grayscale value string; fill a matrix framework determined by the matrix row number and the matrix column number with the grayscale value string according to the number of bits, to obtain an initial matrix; and acquire the target matrix based on the initial matrix.

In an exemplary embodiment, the image acquisition module 20 is further configured to add null values to the initial matrix to obtain a dilated matrix; and dimensionally expand the dilated matrix based on a number of display channels of the video frame, to obtain the target matrix.

In an exemplary embodiment, the image acquisition module 20 is further configured to determine an embedding region of the target matrix; and replace image content in the embedding region with the target matrix, to obtain the embedded image.

In an exemplary embodiment, the image display module 30 is further configured to send a video frame into which an indication matrix is embedded to the second terminal, and display the video frame. The indication matrix is used to prompt the second terminal to prepare to display the embedded image.

In an exemplary embodiment, as shown in FIG. 9, a color temperature adjustment effect detection apparatus is provided, including: a color temperature sending module 40, an image parsing module 50, a color temperature acquisition module 60, and an effect acquisition module 70.

The color temperature sending module 40 is configured to send a real standard color temperature to the first terminal, so that the first terminal acquires an actual used color temperature obtained based on the real standard color temperature, converts the actual used color temperature into a target matrix carrying the actual used color temperature, embeds the target matrix into a video frame to obtain an embedded image, and displays the embedded image based on the actual used color temperature.

The image parsing module 50 is configured to acquire the embedded image returned by the first terminal, and parse the embedded image to obtain the actual used color temperature.

The color temperature acquisition module 60 is configured to acquire an actual rendered color temperature based on a display result of the first terminal.

The effect acquisition module 70 is configured to acquire a color temperature adjustment effect of the first terminal based on the real standard color temperature, the actual used color temperature, and the actual rendered color temperature.

In an exemplary embodiment, the image parsing module 50 is further configured to store acquired embedded images to a cache region based on timestamps of the acquired embedded images; and select, in order of the timestamps, the embedded image corresponding to the earliest timestamp for parsing.

In an exemplary embodiment, the image parsing module 50 is further configured to acquire a target matrix from the embedded image according to an embedding region in the embedded image; dimensionally reduce the target matrix to obtain a dilated matrix; remove null values in the dilated matrix to obtain an initial matrix; and acquire a grayscale value string based on the initial matrix, convert the grayscale value string into a binary string, and convert the binary string into the actual used color temperature.

In an exemplary embodiment, the effect acquisition module 70 is further configured to determine that the adjustment is abnormal when at least one of the actual used color temperature and the actual rendered color temperature is inconsistent with the real standard color temperature; acquire a device number of the first terminal when the adjustment of the first terminal is abnormal; and take the embedded image as abnormal information, and save the abnormal information and the device number to a target database as the color temperature adjustment effect.

The modules in the above color temperature adjustment effect detection apparatus may be wholly or partially implemented by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

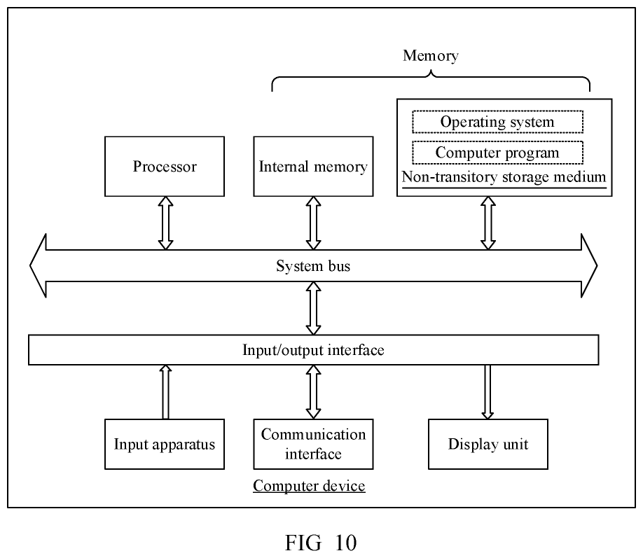

In an exemplary embodiment, a computer device is provided. The computer device may be a first terminal or a second terminal, and a diagram of an internal structure thereof may be shown in FIG. 10. The computer device includes a processor, a memory, an input/output interface, a communication interface, a display unit, and an input apparatus. The processor, the memory, and the input/output interface are connected through a system bus. The communication interface, the display unit, and the input apparatus are connected to the system bus through the input/output interface. The processor of the computer device is configured to provide computing and control capabilities. The memory of the computer device includes a non-transitory storage medium and an internal memory. The non-transitory storage medium stores an operating system and a computer program. The internal memory provides an environment for running of the operating system and the computer program in the non-transitory storage medium. The input/output interface of the computer device is configured to exchange information between the processor and an external device. The communication interface of the computer device is configured to communicate with an external terminal in a wired or wireless manner. The wireless manner may be implemented through WIFI, a mobile cellular network, near field communication (NFC), or another technology. The computer program is executed by the processor to implement a color temperature adjustment effect detection method. The display unit of the computer device is configured to form a visually visible picture, which may be a display screen, a projection apparatus, or a virtual reality imaging apparatus. The display screen may be a liquid crystal display screen or an electronic ink display screen. The input apparatus of the computer device may be a touch layer covering the display screen, or may be a key, a trackball, or a touch pad disposed on a housing of the computer device, or may be an external keyboard, a touch pad, a mouse, or the like.

Those skilled in the art may understand that, in the structure shown in FIG. 10, only a block diagram of a partial structure related to a solution of the present disclosure is shown, which does not constitute a limitation on the computer device to which the solution of the present disclosure is applied. Specifically, the computer device may include more or fewer components than those shown in the figure, or some components may be combined, or a different component deployment may be used.

In an exemplary embodiment, a computer device is provided, including a memory and a processor. The memory stores a computer program. The processor, when executing the computer program, implements the following steps: acquiring an actual used color temperature obtained based on a real standard color temperature sent by a second terminal; converting the actual used color temperature into a target matrix carrying the actual used color temperature, embedding the target matrix into a video frame to obtain an embedded image, displaying the embedded image based on the actual used color temperature, and sending the embedded image to the second terminal, so that the second terminal analyzes the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

In an embodiment, the converting the actual used color temperature into the target matrix carrying the actual used color temperature when the processor executes the computer program includes: converting the actual used color temperature into a binary string, and converting the binary string into a grayscale value string; determining a matrix row number and a matrix column number according to a number of bits of the grayscale value string; filling a matrix framework determined by the matrix row number and the matrix column number with the grayscale value string according to the number of bits, to obtain an initial matrix; and acquiring the target matrix based on the initial matrix.

In an embodiment, the acquiring the target matrix based on the initial matrix when the processor executes the computer program includes: adding null values to the initial matrix to obtain a dilated matrix; and dimensionally expanding the dilated matrix based on a number of display channels of the video frame, to obtain the target matrix.

In an embodiment, the embedding the target matrix into the video frame to obtain the embedded image when the processor executes the computer program includes: determining an embedding region of the target matrix; and replacing image content in the embedding region with the target matrix, to obtain the embedded image.

In an embodiment, prior to the sending the embedded image to the second terminal when the processor executes the computer program, the following steps are further included: sending a video frame into which an indication matrix is embedded to the second terminal, and displaying the video frame, the indication matrix being configured to prompt the second terminal to prepare to display the embedded image.

In an embodiment, a computer device is provided, including a memory and a processor. The memory stores a computer program. The processor, when executing the computer program, implements the following steps: sending a real standard color temperature to the first terminal, so that the first terminal acquires an actual used color temperature obtained based on the real standard color temperature, converts the actual used color temperature into a target matrix carrying the actual used color temperature, embeds the target matrix into a video frame to obtain an embedded image, and displays the embedded image based on the actual used color temperature; acquiring the embedded image returned by the first terminal, and parsing the embedded image to obtain the actual used color temperature; acquiring an actual rendered color temperature based on a display result of the first terminal; and acquiring a color temperature adjustment effect of the first terminal based on the real standard color temperature, the actual used color temperature, and the actual rendered color temperature.

In an embodiment, prior to the parsing the embedded image when the processor executes the computer program, the following steps are further included: storing acquired embedded images to a cache region based on timestamps of the acquired embedded images; and selecting, in order of the timestamps, the embedded image corresponding to the earliest timestamp for parsing.

In an embodiment, the parsing the embedded image to obtain the actual used color temperature when the processor executes the computer program includes: acquiring a target matrix from the embedded image according to an embedding region in the embedded image; dimensionally reducing the target matrix to obtain a dilated matrix; removing null values in the dilated matrix to obtain an initial matrix; and acquiring a grayscale value string based on the initial matrix, converting the grayscale value string into a binary string, and converting the binary string into the actual used color temperature.

In an embodiment, the acquiring the color temperature adjustment effect of the first terminal based on the real standard color temperature, the actual used color temperature, and the actual rendered color temperature when the processor executes the computer program includes: determining that the adjustment is abnormal when at least one of the actual used color temperature and the actual rendered color temperature is inconsistent with the real standard color temperature; acquiring a device number of the first terminal when the adjustment of the first terminal is abnormal; and taking the embedded image as abnormal information, and saving the abnormal information and the device number to a target database as the color temperature adjustment effect.

In an embodiment, a computer-readable storage medium is provided, storing a computer program. When the computer program is executed by a processor, the following steps are implemented: acquiring an actual used color temperature obtained based on a real standard color temperature sent by a second terminal; converting the actual used color temperature into a target matrix carrying the actual used color temperature, embedding the target matrix into a video frame to obtain an embedded image, displaying the embedded image based on the actual used color temperature, and sending the embedded image to the second terminal, so that the second terminal analyzes the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

In an embodiment, the converting the actual used color temperature into the target matrix carrying the actual used color temperature when the computer program is executed by the processor includes: converting the actual used color temperature into a binary string, and converting the binary string into a grayscale value string; determining a matrix row number and a matrix column number according to a number of bits of the grayscale value string; filling a matrix framework determined by the matrix row number and the matrix column number with the grayscale value string according to the number of bits, to obtain an initial matrix; and acquiring the target matrix based on the initial matrix.

In an embodiment, the acquiring the target matrix based on the initial matrix when the computer program is executed by the processor includes: adding null values to the initial matrix to obtain a dilated matrix; and dimensionally expanding the dilated matrix based on a number of display channels of the video frame, to obtain the target matrix.

In an embodiment, the embedding the target matrix into the video frame to obtain the embedded image when the computer program is executed by the processor includes: determining an embedding region of the target matrix; and replacing image content in the embedding region with the target matrix, to obtain the embedded image.

In an embodiment, prior to the sending the embedded image to the second terminal when the computer program is executed by the processor, the following steps are further included: sending a video frame into which an indication matrix is embedded to the second terminal, and displaying the video frame, the indication matrix being configured to prompt the second terminal to prepare to display the embedded image.

In an embodiment, a computer-readable storage medium is provided, storing a computer program. When the computer program is executed by a processor, the following steps are implemented: sending a real standard color temperature to the first terminal, so that the first terminal acquires an actual used color temperature obtained based on the real standard color temperature, converts the actual used color temperature into a target matrix carrying the actual used color temperature, embeds the target matrix into a video frame to obtain an embedded image, and displays the embedded image based on the actual used color temperature; acquiring the embedded image returned by the first terminal, and parsing the embedded image to obtain the actual used color temperature; acquiring an actual rendered color temperature based on a display result of the first terminal; and acquiring a color temperature adjustment effect of the first terminal based on the real standard color temperature, the actual used color temperature, and the actual rendered color temperature.

In an embodiment, prior to the parsing the embedded image when the computer program is executed by the processor, the following steps are further included: storing acquired embedded images to a cache region based on timestamps of the acquired embedded images; and selecting, in order of the timestamps, the embedded image corresponding to the earliest timestamp for parsing.

In an embodiment, the parsing the embedded image to obtain the actual used color temperature when the computer program is executed by the processor includes: acquiring a target matrix from the embedded image according to an embedding region in the embedded image; dimensionally reducing the target matrix to obtain a dilated matrix; removing null values in the dilated matrix to obtain an initial matrix; and acquiring a grayscale value string based on the initial matrix, converting the grayscale value string into a binary string, and converting the binary string into the actual used color temperature.

In an embodiment, the acquiring the color temperature adjustment effect of the first terminal based on the real standard color temperature, the actual used color temperature, and the actual rendered color temperature when the computer program is executed by the processor includes: determining that the adjustment is abnormal when at least one of the actual used color temperature and the actual rendered color temperature is inconsistent with the real standard color temperature; acquiring a device number of the first terminal when the adjustment of the first terminal is abnormal; and taking the embedded image as abnormal information, and saving the abnormal information and the device number to a target database as the color temperature adjustment effect.

In an embodiment, a computer program product is provided, including a computer program. When the computer program is executed by a processor, the following steps are implemented: acquiring an actual used color temperature obtained based on a real standard color temperature sent by a second terminal; converting the actual used color temperature into a target matrix carrying the actual used color temperature, embedding the target matrix into a video frame to obtain an embedded image, displaying the embedded image based on the actual used color temperature, and sending the embedded image to the second terminal, so that the second terminal analyzes the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

In an embodiment, the converting the actual used color temperature into the target matrix carrying the actual used color temperature when the computer program is executed by the processor includes: converting the actual used color temperature into a binary string, and converting the binary string into a grayscale value string; determining a matrix row number and a matrix column number according to a number of bits of the grayscale value string; filling a matrix framework determined by the matrix row number and the matrix column number with the grayscale value string according to the number of bits, to obtain an initial matrix; and acquiring the target matrix based on the initial matrix.

In an embodiment, the acquiring the target matrix based on the initial matrix when the computer program is executed by the processor includes: adding null values to the initial matrix to obtain a dilated matrix; and dimensionally expanding the dilated matrix based on a number of display channels of the video frame, to obtain the target matrix.

In an embodiment, the embedding the target matrix into the video frame to obtain the embedded image when the computer program is executed by the processor includes: determining an embedding region of the target matrix; and replacing image content in the embedding region with the target matrix, to obtain the embedded image.

In an embodiment, prior to the sending the embedded image to the second terminal when the computer program is executed by the processor, the following steps are further included: sending a video frame into which an indication matrix is embedded to the second terminal, and displaying the video frame, the indication matrix being configured to prompt the second terminal to prepare to display the embedded image.

In an embodiment, a computer program product is provided, including a computer program. When the computer program is executed by a processor, the following steps are implemented: sending a real standard color temperature to the first terminal, so that the first terminal acquires an actual used color temperature obtained based on the real standard color temperature, converts the actual used color temperature into a target matrix carrying the actual used color temperature, embeds the target matrix into a video frame to obtain an embedded image, and displays the embedded image based on the actual used color temperature; acquiring the embedded image returned by the first terminal, and parsing the embedded image to obtain the actual used color temperature; acquiring an actual rendered color temperature based on a display result of the first terminal; and acquiring a color temperature adjustment effect of the first terminal based on the real standard color temperature, the actual used color temperature, and the actual rendered color temperature.

In an embodiment, prior to the parsing the embedded image when the computer program is executed by the processor, the following steps are further included: storing acquired embedded images to a cache region based on timestamps of the acquired embedded images; and selecting, in order of the timestamps, the embedded image corresponding to the earliest timestamp for parsing.

In an embodiment, the parsing the embedded image to obtain the actual used color temperature when the computer program is executed by the processor includes: acquiring a target matrix from the embedded image according to an embedding region in the embedded image; dimensionally reducing the target matrix to obtain a dilated matrix; removing null values in the dilated matrix to obtain an initial matrix; and acquiring a grayscale value string based on the initial matrix, converting the grayscale value string into a binary string, and converting the binary string into the actual used color temperature.

In an embodiment, the acquiring the color temperature adjustment effect of the first terminal based on the real standard color temperature, the actual used color temperature, and the actual rendered color temperature when the computer program is executed by the processor includes: determining that the adjustment is abnormal when at least one of the actual used color temperature and the actual rendered color temperature is inconsistent with the real standard color temperature; acquiring a device number of the first terminal when the adjustment of the first terminal is abnormal; and taking the embedded image as abnormal information, and saving the abnormal information and the device number to a target database as the color temperature adjustment effect.

Those of ordinary skill in the art may understand that some or all procedures in the methods in the foregoing embodiments may be implemented by a computer program instructing related hardware, the computer program may be stored in a non-transitory computer-readable storage medium, and when the computer program is executed, the flows in the foregoing method embodiments may be implemented. Any reference to the memory, the database, or other media used in the embodiments provided in the present disclosure may include at least one of a non-transitory memory and a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The transitory memory may include a random access memory (RAM) or an external cache memory. By way of illustration instead of limitation, the RAM is available in a variety of forms, such as a static RAM (SRAM) or a dynamic RAM (DRAM). The database involved in the embodiments provided in the present disclosure may include at least one of a relational database and a non-relational database. The non-relational database may include a blockchain-based distributed database and the like, but is not limited thereto. The processor involved in the embodiments provided in the present disclosure may be a general-purpose processor, a central processing unit, a GPU, a digital signal processor, a programmable logic device, a data processing logic device based on quantum computing, and the like, and is not limited thereto.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and the description thereof is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the protection scope of the present disclosure should be subject to the appended claims.

What is claimed is:

1. A color temperature adjustment effect detection method, applied to a first terminal, the method comprising:
acquiring an actual used color temperature obtained based on a real standard color temperature sent by a second terminal;
converting the actual used color temperature into a target matrix carrying the actual used color temperature, and embedding the target matrix into a video frame to obtain an embedded image;
displaying the embedded image based on the actual used color temperature, and sending the embedded image to the second terminal, so that the second terminal parses the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

2. The method according to claim 1, wherein the converting the actual used color temperature into the target matrix carrying the actual used color temperature comprises:
converting the actual used color temperature into a binary string, and converting the binary string into a grayscale value string;
determining a matrix row number and a matrix column number according to a number of bits of the grayscale value string;
filling a matrix framework determined by the matrix row number and the matrix column number with the grayscale value string according to the number of bits, to obtain an initial matrix;
acquiring the target matrix based on the initial matrix.

3. The method according to claim 2, wherein the acquiring the target matrix based on the initial matrix comprises:
adding null values to the initial matrix to obtain a dilated matrix;
dimensionally expanding the dilated matrix based on a number of display channels of the video frame, to obtain the target matrix.

4. The method according to claim 1, wherein the embedding the target matrix into the video frame to obtain the embedded image comprises:
determining an embedding region of the target matrix;
replacing image content in the embedding region with the target matrix, to obtain the embedded image.

5. The method according to claim 1, further comprising: prior to the sending the embedded image to the second terminal,
sending a video frame into which an indication matrix is embedded to the second terminal, and displaying the video frame, the indication matrix being configured to prompt the second terminal to prepare to display the embedded image.

6. A color temperature adjustment effect detection method, applied to a second terminal, the method comprising:
sending a real standard color temperature to the first terminal, so that the first terminal acquires an actual used color temperature obtained based on the real standard color temperature, converts the actual used color temperature into a target matrix carrying the actual used color temperature, embeds the target matrix into a video frame to obtain an embedded image, and displays the embedded image based on the actual used color temperature;
acquiring the embedded image returned by the first terminal, and parsing the embedded image to obtain the actual used color temperature;
acquiring an actual rendered color temperature based on a display result of the first terminal;
acquiring a color temperature adjustment effect of the first terminal based on the real standard color temperature, the actual used color temperature, and the actual rendered color temperature.

7. The method according to claim 6, further comprising: prior to the parsing the embedded image,
storing acquired embedded images to a cache region based on timestamps of the acquired embedded images;
selecting, in order of the timestamps, the embedded image corresponding to the earliest timestamp for parsing.

8. The method according to claim 6, wherein the parsing the embedded image to obtain the actual used color temperature comprises:
acquiring the target matrix from the embedded image according to an embedding region in the embedded image;
dimensionally reducing the target matrix to obtain a dilated matrix;
removing null values in the dilated matrix to obtain an initial matrix;
acquiring a grayscale value string based on the initial matrix, converting the grayscale value string into a binary string, and converting the binary string into the actual used color temperature.

9. The method according to claim 6, wherein the acquiring the color temperature adjustment effect of the first terminal based on the real standard color temperature, the actual used color temperature, and the actual rendered color temperature comprises:
determining that the adjustment is abnormal when at least one of the actual used color temperature and the actual rendered color temperature is inconsistent with the real standard color temperature;
acquiring a device number of the first terminal when the adjustment of the first terminal is abnormal;
taking the embedded image as abnormal information, and saving the abnormal information and the device number to a target database as the color temperature adjustment effect.

10. A color temperature adjustment effect detection apparatus, comprising:
a color temperature acquisition module configured to acquire an actual used color temperature obtained based on a real standard color temperature sent by a second terminal;
an image acquisition module configured to convert the actual used color temperature into a target matrix carrying the actual used color temperature, and embed the target matrix into a video frame to obtain an embedded image;
an image display module configured to display the embedded image based on the actual used color temperature, and send the embedded image to the second terminal, so that the second terminal analyzes the embedded image to obtain the actual used color temperature, acquires an actual rendered color temperature based on a display result, and acquires a color temperature adjustment effect of the first terminal based on the real standard color temperature, the actual used color temperature, and the actual rendered color temperature.

11. A computer device, comprising a memory and a processor, the memory storing a computer program, wherein the processor, when executing the computer program, implements steps in the method according to claim 1.

12. A computer-readable storage medium, storing a computer program, wherein, when the computer program is executed by a processor, steps in the method according to claim 1 are implemented.

13. A computer program product, comprising a computer program, wherein, when the computer program is executed by a processor, steps in the method according to claim 1 are implemented.
